(19) United States
(12) Patent Application Publication
(10) Pub. No.: US 2001/0030429 A1
(43) Pub. Date: Oct. 18, 2001

(54) Lock mechanism

(76) Inventors: Heng-Chih Yen, Taipei (TW); Yih Yu, Taipei (TW)

Correspondence Address: Michael D. Bednarek, SHAWPITTMAN, 1650 Tysons Boulevard, McLean, VA, 22102-4859, US

(21) Appl. No.: 09/790,565

(22) Filed: Feb. 23, 2001

(30) Foreign Application Priority Data
Apr. 12, 2000 (TW) 089205887

(51) Int. Cl. E05C 3/04

(52) U.S. Cl. 292/207

(57) ABSTRACT

A host of a personal computer is equipped with a lock mechanism used to connect or disconnect a door to or form the host. A clicking sound can be generated by the lock mechanism so as to notify the user that the door is already disconnected from the host. The host comprises a body, a door, a gate and a lock mechanism. The body is a case provided with a port and the door is pivoted on the body, and the gate also provided with another port which is movably mounted on the body. The lock mechanism is mounted on the door and used to connect or disconnect the door and gate to or from the body. The lock mechanism is composed of a first latch and a second latch. The first latch has a first portion which can be moved between a first position and a second position and used to connect the port of the body, and a button which is used to drive the first portion to connect or disconnect to or from the body. The first latch further comprises a first resilient member which is connected to the button, and a second resilient member which is connected to the first portion. The second latch has a second portion which is moved between a third position and a fourth position and used to limit the first portion.

### REFERENCE TO RELATED APPLICATION

The present application claims priority to Taiwan Application No. 089205887 entitled “Lock Mechanism” filed on Apr. 12, 2000.

### BACKGROUND OF THE INVENTION

1. Field of the Invention

This invention relates to a lock mechanism. More particularly, this invention relates to a lock mechanism which is used to connect or disconnect a door to or from a host of a computer and generates a clicking sound to notify the user that the door is already disconnected from the host.

2. Description of Prior Art

In general, hosts of computer have a body such a case or housing which is constructed on the outer structure of the host and is usually pivoted with a door. A lock is generally mounted on the door so as to connect or disconnect the door to or from the body. Some locks are equipped with a single button used as a trigger to lock or unlock the door to the body. Once the user wants to open the door with her or his finger, the button always has to be deeply pressed and there is no sound generated to notify the user when the finger may be released.

### SUMMARY OF THE INVENTION

To solve the above problem, the primary object of this invention is to provide a lock mechanism to connect a door to a host of a personal computer. A clicking sound can be generated by the lock mechanism so as to notify the user that the door is already disconnected from the host and it can be freely opened.

The host mainly comprises a body, a door, a gate and a lock mechanism. The body is a case provided with a port and the door which is pivoted on the body, and the gate also provided with another port which is movably mounted on the body. The lock mechanism is mounted on the door and used to connect or disconnect the door and gate to or from the body. The lock mechanism is composed of a first latch and a second latch. The first latch has a first portion which can be moved between a first position and a second position and used to connect the port of the body and a button which is used to drive the first portion to connect or disconnect to or from the body. The first latch further comprises a first resilient member which is connected to the button, and a second resilient member which is connected to the first portion. The second latch has a second portion which is moved between a third position and a fourth position and used to limit the first portion.

### BRIEF DESCRIPTION OF THE DRAWINGS

The present invention can be more fully understood by reading the subsequent detailed description and examples with reference made to accompanying drawings in which:

FIG. 1A is a perspective view showing the outer structure of a host of a personal computer, which is constructed by a door (21) equipped with a lock mechanism (1), a body (22) and a gate (23);

FIG. 1B is a perspective view showing the other state of host according to FIG. 1A;

FIG. 2A is a perspective view showing the structure of the door (21) equipped with the lock mechanism (1) according to FIG. 1B;

FIG. 2B is an enlarged perspective view showing the structure of the lock mechanism (1), comprising a first latch (11) and a second latch (12), according to the area within the dotted line of FIG. 2A;

FIG. 2C is a perspective view showing the structure of a button (11-1) of the first latch (11) according to FIG. 2B;

FIG. 3A is a perspective view showing the button (11-1) being pressed by a force (F) according to FIG. 2A;

FIG. 3B is an enlarged perspective view showing the structure of the lock mechanism (1) according to the area within the dotted line of FIG. 3A;

FIG. 4A is a perspective view showing the structure of the lock mechanism (1) being actuated by the key (3); and

FIG. 4B is an enlarged perspective view showing the structure of the lock mechanism (1) according to the area within the dotted line of FIG. 4A.

### DETAILED DESCRIPTION OF THE PREFERRED EMBODIMENTS

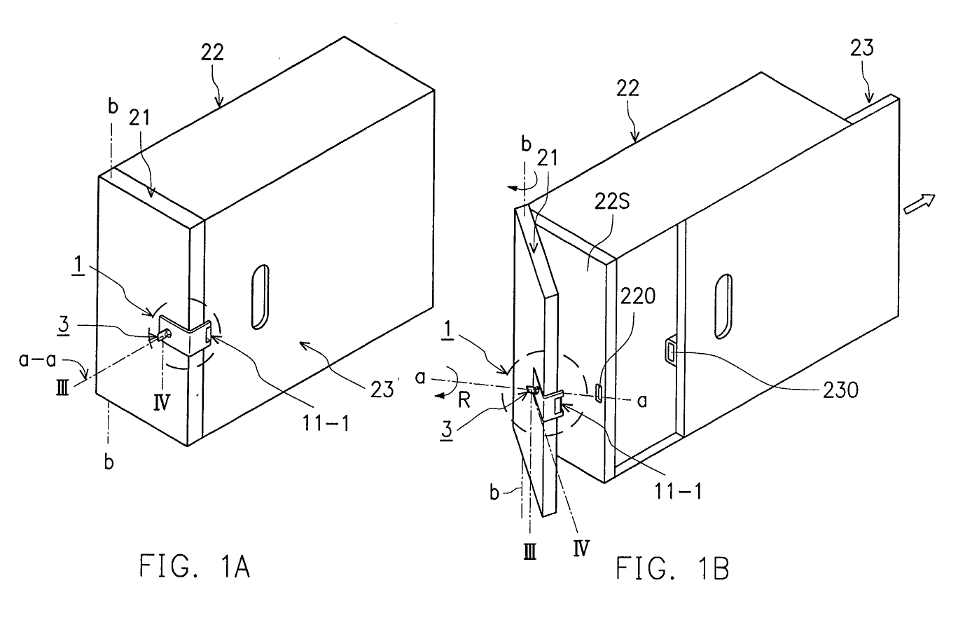

FIG. 1A shows a perspective view of the structure of a host of a personal computer, and FIG. 1B shows a perspective view of the other state of the host according to FIG. 1A.

In FIG. 1B, a door 21 and a body 22 and a gate 23 construct the outer structure of the host. The body 22 is a rectangular case provided with a connecting port 220, which is penetrated through its front surface 22S, and the door 21 is pivoted on the body 22 along the line b-b. A lock mechanism 1, a switching device used to lock or unlock the door 21 and the gate 23 to or from the body 22 is mounted on the door 21 and controlled by a key 3 which is rotated about the line a-a. The gate 23 is a movable plate disposed on one side of the body 22 and provided with another connecting port 230 thereon. With the lock mechanism 1 being connected to the connecting port 220 of the body 22, the door 21 can be closed, and the gate 23 can be latched connected to the body 22 with its connecting port 230 latched by the lock mechanism 1.

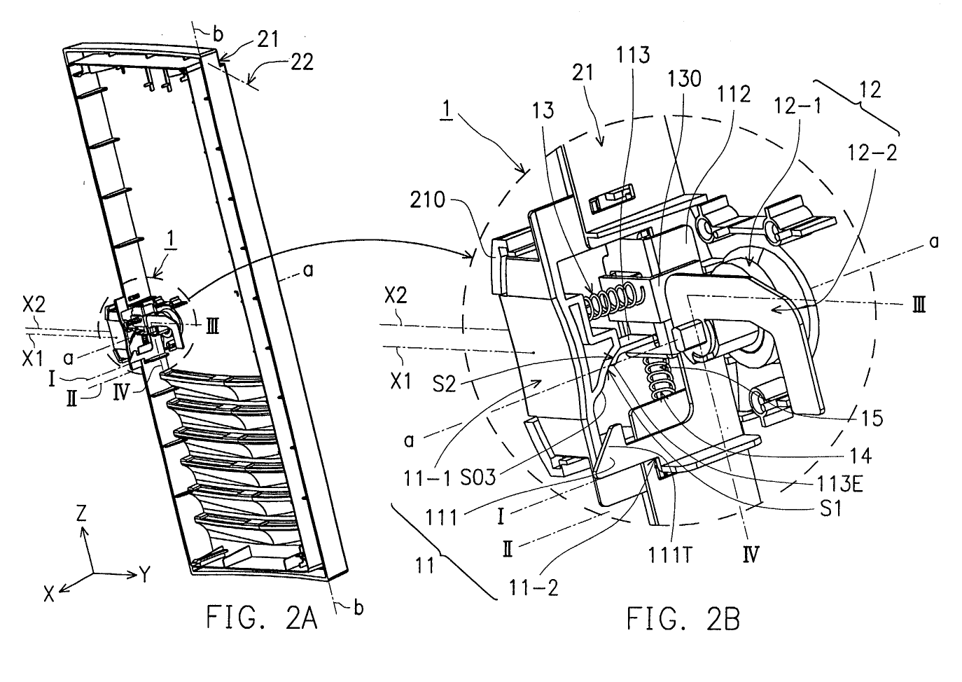

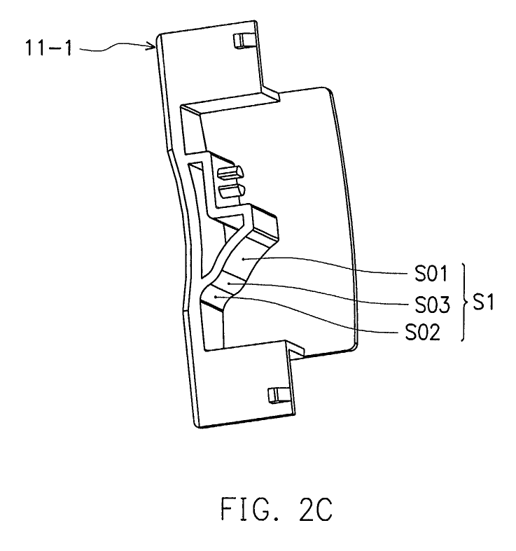

FIG. 2A shows a perspective view of the structure of the door 21 which is equipped with the lock mechanism 1, and FIG. 2B shows the enlarged view of the lock mechanism 1 according to the area within the dotted line of FIG. 2A.

In FIG. 2A, Cartesian coordinates X-Y-Z are used to define the structure and geometrical relationships among all the movements of the lock mechanism 1. Line b-b, along which the door 21 is pivoted to the body 22, is substantially parallel to the Z-axis, and the line a-a that is the key 3 rotated about is substantially parallel to the X-axis.

As shown in FIG. 2B, the lock mechanism 1 is composed of a first latch 11 and a second latch 12, which can be movably actuated by each other and both mounted on the door 21. The first latch 11 comprises a button 11 - 1, a first portion 11 -2, a first resilient member 13 and a second resilient member 14; the second latch 12 comprises a shaft 12-1 and a second portion 12-2. The shaft 12-1 is pivotally mounted on the door 21 and controlled by the key 3, and the second portion 12-2 is an L-shape element connected to the shaft 12-1. Both the first resilient member 13 and the second resilient member 14 are preferably made of coil springs.

Referring also to FIG. 2C, FIG. 2C shows the structure of the button 11-1 of the first latch 11. The button 11-1 has a first surface S1, which is a curved surface and used as a thrusting surface. The first surface S1 can be divided into three areas: a first face S01, a second face S02 and a third face S03 which is located between and next to the first face S01 and the second face S02.

In FIG. 2B, the button 11-1 is a movable element, which is fitted into a guiding slot 210 formed on the door 21 and can be moved reciprocally between an initial position X1 and a predetermined position X2. A guiding seat 130 is a hollow portion formed on the door 21, and the first resilient member 13 is disposed between the button 11-1 and the guiding seat 130. The guided button 11-1, therefore, can be moved back and forth from the initial position X1 to the predetermined position X2 by the first resilient member 13 according to user's pressing or releasing, and the released button 11-1 can be automatically positioned at the first position X1.

A post 15, an element for guiding and positioning the second resilient member 14 thereon, is fixedly positioned on the door 21 and located within the hollow guiding seat 130. The first portion 11-2 is an L-shaped element that is integrally formed by three parts: a hook rod 111 provided with a slant surface 111T, a hollow slider 112 and a curved plate 113 provided with a second surface S2. The hollow slider 112 is movably fitted into the guiding seat 130 and is adjacent to the second resilient member 14 with its sidewall. The second surface S2 of the curved plate 113 is also used as a thrusting surface and always contacts the first surface S1 of the button 11-1.

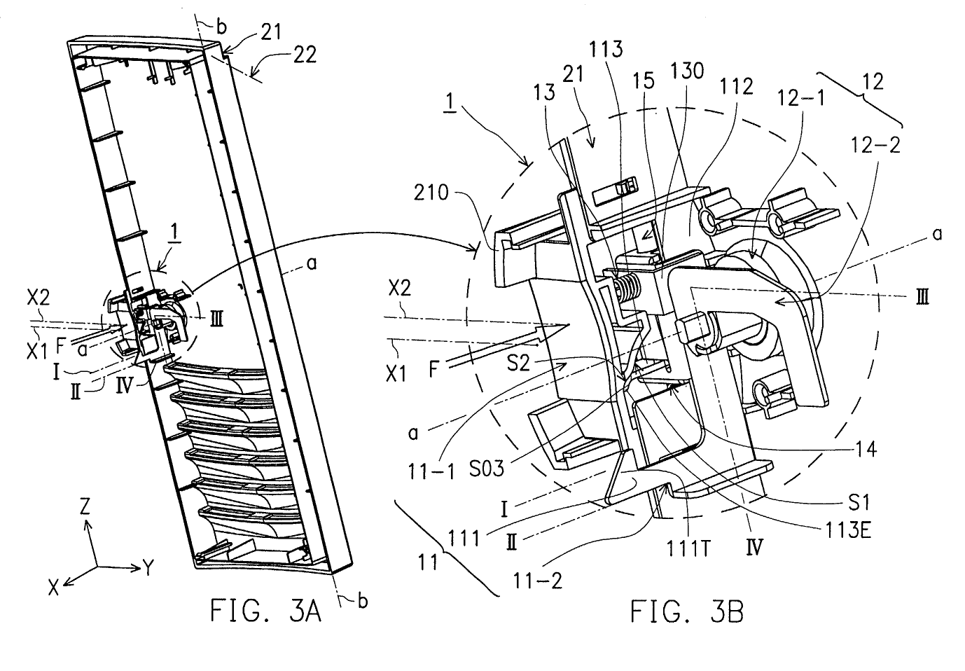

Refer to FIGS. 3A and 3B. FIG. 3A shows the button 11-1 of the lock mechanism 1 pressed by a force F, and FIG. 3B shows the enlarged view of the lock mechanism 1 according to the area within the dotted line of FIG. 3A.

As the force F is applied on the button 11-1, the energized button 11-1 is moved from the initial position X1 toward the predetermined position X2. Then, the first surface S1 of the button 11-1 slides on the second surface S2 of the curved plate 113 so as to thrust it into the first portion 11-2. A clicking sound can be generated therebetween at the moment that the second surface S2 of the curved plate 113 is rubbed by the button 11-1 from its first face S01 to the second face S02, respectively. Then, the hollow slider 112 is synchronously moved and the second resilient member 14 is compressed, and the hook rod 111 can be moved from a first position I toward a second position II. When the button 11-1 is fully pressed, the second surface S2 of the curved plate 113 is located exactly at the second face S02 of the button 11-1, and the hook rod 111 is positioned at the second position II. As the force F is totally released, both the compressed first resilient member 13 and the compressed second resilient member 14 can be released, and then the button 11-1 is automatically moved back to the initial position X1.

By pressing the door 21 onto the body 22 and letting the hook rod 111 slide into the connecting port 220 (body 22) and the connecting port 230 (gate 23) with its slant surface 111T, the door 21 and the gate 23 can be connected to the body 22. Then, the door 21 and the gate 23 cannot be opened unless the force F is applied on the button 111 of the lock mechanism 1. If user wants to open the door 21, he or she has to push the button 11-1 until the clicking sound is generated, and then the door 21 can be freely rotated away from the body 22 above the axis b-b. Then, the gate 23 also can be disconnected from the body 22 while the door 21 is open.

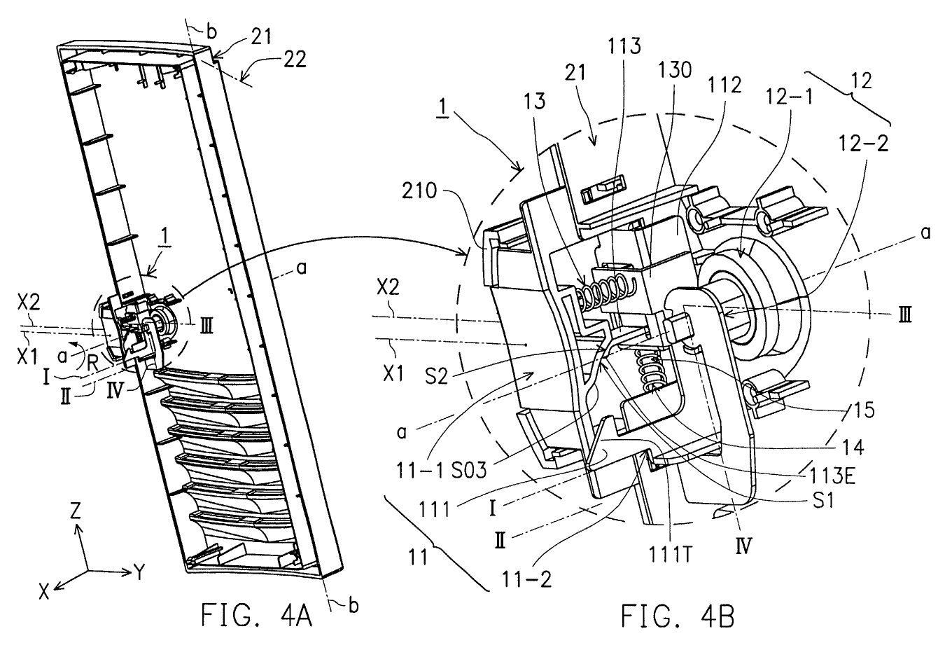

FIG. 4A shows the structure of the lock mechanism 1 being actuated by the key 3, and FIG. 4B shows an enlarged perspective view according to the area within the dotted line of FIG. 4A.

As the key 3 is used to drive the shaft 12-1 rotating along the axis a-a counterclockwise, the L-shaped second portion 12-2 is synchronously moved from a third position III to a fourth position IV. When the second portion 12-2 is positioned at the fourth position IV, the second portion 12-2 is used as a distilling portion adjacent to the first portion 11-2 and to limit the movement of the first portion 11-2. Thus, the closing door 21 cannot be opened even though the force F is applied again on the button 11-1.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. An apparatus for locking a door to a body provided with a connecting port, comprising:
a first latch mounted on the door, having a first portion which is moved between a first position and a second position used to connect the connecting port; and
a second latch mounted on the door, having a second portion which is moved between a third position and a fourth position and used to limit the first portion.

2. The apparatus as claimed in claim 1, wherein the first latch further comprises a button which is connected to and used to drive the first portion.

3. The apparatus as claimed in claim 2, wherein the button has a first surface and the first portion has a second surface contacted with the first surface.

4. The apparatus as claimed in claim 3, wherein a sound is generated between the first surface and the second surface as they slide by each other while the button is pushed.

5. The apparatus as claimed in claim 2, wherein the first latch further comprises a first resilient member which is used to connect to the button, and a second resilient member which is used to connect to the first portion.

6. The apparatus as claimed in claim 5, wherein the first resilient member and the second resilient member are springs.

7. The apparatus as claimed in claim 3, wherein the first surface is a curved surface.

8. The apparatus as claimed in claim 1, wherein the second latch further comprises a shaft which is connected to the second portion.

9. An apparatus for locking a door to a body provided with a connecting port, comprising:
a first latch mounted on the door, having a first portion which is moved between a first position and a second position and used to connect the connecting port, a button which is connected to and used to drive the first portion, a first resilient member which is used to connect to the button, and a second resilient member which is used to connect to the first portion; and
a second latch mounted on the door, having a second portion which is moved between a third position and a fourth position and used to limit the first portion.

10. The apparatus as claimed in claim 9, wherein the button has a first surface and the first portion has a second surface contacted with the first surface.

11. The apparatus as claimed in claim 10, wherein a sound is generated between the first surface and the second surface as they slide by each other while the button is pushed.

12. The apparatus as claimed in claim 9, wherein the first resilient member and the second resilient member are springs.

13. The apparatus as claimed in claim 10, wherein the first surface is a curved surface.

14. The apparatus as claimed in claim 9, wherein the second latch further comprises a shaft which is connected to the second portion.
